(19) United States
(12) Patent Application Publication
(10) Pub. No.: US 2002/0034269 A1
(43) Pub. Date: Mar. 21, 2002

(54) Use of soft-decision or sum-product inner coders to improve the performance of outer coders

(76) Inventors: Victor Demjanenko, Pendleton, NY (US); Frederic J. Hirzel, Clinton Township, MI (US); Juan Alberto Torres, Orchard Park, NY (US)

Correspondence Address: Ronald Coslick, Foley & Lardner, Suite 3500, 2029 Century Park East, Los Angeles, CA, 90067-3021, US

(21) Appl. No.: 09/916,865

(22) Filed: Jul. 27, 2001

Related U.S. Application Data
(60) Provisional application No. 60/221,851, filed on Jul. 28, 2000.

(51) Int. Cl. H04L 27/06

(52) U.S. Cl. 375/341

(57) ABSTRACT

In a receiver, an outer decoder in an inner/outer decoder scheme receives bit error information or bit error probability information from an inner decoder rather than being generated internally by the outer decoder. The inner decoder may be a soft-decision decoder that provides bit error probabilities, or a sum-product decoder that provides bit error information. Thus, unlike conventional outer decoders, the outer decoder does not require a conventional first stage for determining errors in the output bit stream of the inner decoder based on the bits of the output bit stream themselves. A related transmitter uses a sum-product inner decoder in conjunction with an outer decoder.

### RELATED APPLICATIONS

This application claims the benefit under 35 U.S.C. Section 119(e) of United States Provisional Patent Application Serial No. 60/221,851, filed on Jul. 28, 2000, incorporated herein by reference in its entirety.

This application incorporates by reference the entire teachings of: U.S. patent application Ser. No. 09/846,061 entitled “Use of turbo-like codes for QAM modulation using independent I and Q decoding techniques and application to xDSL systems”; U.S. Patent Application PCT/US99/17369 entitled “Method and apparatus for design forward error correction techniques in data transmission over communications systems”; and U.S. Provisional Patent Application Ser. No. 09/702,827 entitled “Use of Turbo Trellis codes with QAM modulation for xDSL modems and other wired and wireless modems.”

### FIELD OF THE INVENTION

Embodiments of the invention pertain to encoder structures comprising an inner encoder, such as a Trellis Code Modulation (TCM), Turbo Code (TC) or Low Density Parity Check (LDPC) coder, and an outer encoder such as a Reed-Solomon (RS) encoder or another outer encoder. Further embodiments pertain to a corresponding decoder structure comprising an inner decoder and an outer decoder.

### BACKGROUND TECHNOLOGY

Turbo codes and other receiver soft-decision extraction techniques such as Low Density Parity Check Codes (LDPC), are powerful error control techniques that allow communication at very close to the channel capacity. Low Density Parity Check Codes were introduced in 1962. The sum-product algorithm is commonly used to decode LDPC codes. The sum-product algorithm sends information forward and backward between the information bits and the parity bits iteratively, until all the bits are decoder correctly or some bits are indentified as incorrectly decoded. Consequently the sum-product algorithm provides bit error information that indicates which outputted decoded bits have errors.

LDPC encoders and decoders are conventionally used alone, and are not conventionally used in dual inner/outer coder arrangements. The efficiency of LDPC coding increases with the number of coded bits, and so conventional LDPC implementations have typically used large block sizes (e.g. one megabit) for encoding in order to achieve nearly error free operation. However, since an entire block must be received before an LDPC decoder can decode the block, the use of large blocks can introduce significant delay into the system at the receiver.

Turbo codes were introduced in 1993. Turbo-type decoders, referred to hereinafter as soft-output decoders, provide bit error probability information that indicates a probability of error for each of the decoded bits.

The use of an outer coder, such as a Reed-Solomon (RS) coder, in conjunction with an inner coder, enables errors remaining from an inner coder to be corrected by the outer coder. A RS decoder is able to correct up to R/2 errors without having information of the location of the errors. A RS decoder is able to correct up to R errors if the decoder knows where the errors are located. It is therefore desirable for an outer coder to have information indicating where errors are located. Thus the conventional outer decoder comprises two stages. The first stage receives an output bit stream from an inner decoder and determines which of the received bits have errors. The second stage uses the information generated by the first stage to selectively correct errors in the output bit stream of the inner decoder.

Examples of the use of inner and outer coders are found in the ADSL ITU recommendation G.992.1 and in the Third Mobile Generation Standard UMTS 3GPP 3G TS 25.212 V3.2.0.

The following references are incorporated by reference as representing the conventional knowledge in the field of the invention:

R. G. Gallager, “Low Density Parity-Check Codes”, IRE Trans. on Information Theory, pp. 21-Jan. 28 1962.

C. Berrou, V. Glavieux and P. Thitimajshima, “Near Shannon limit error-correcting coding and decoding: turbo-codes”, ICC 1993, Geneva, Switzerland, pp. 1064-1070, May 1993.

H. Feldman and D. V. Ramana, “An introduction to Inmarsat's New Mobile Multimedia Service”, The Sixth International Mobile Satellite Conference, Ottawa, pp. 226-229, June 1999.

P. Chaudhury, W. Mohr and S. Onoe, “The 3GPP Proposal for IMT-2000”, IEEE Communications Magazine, vol. 37, no 12, pp.72-81. December 1999.

3GPP Standard “Multiplexing and channel coding: TS 25.212”

C. D. Edwards, C. T. Stelzried, L. J. Deutsch and L. Swanson, “NASAS's deep-Space Telecommunications Road Map” TMO Progress Report 42-136, JPL, Pasadena, Calif. USA. PP. 1-20 February 1999.

R. Pyndiah, A. Picard and A. Glavieux “Performance of Block Turbo Coded 16 QAM and 64 QAM modulations” Procedings of Globecom 95 pp. 1039-1043.

Rauschmayer, Dennis J. “ADSLNVDSL Principles”, Macmillan Technical Publishing, 1999.

ITU G.992.1 “ADSL Transceivers”, ITU, 1999.

ITU G.992.2 “Splitterless ADSL Transceivers”. ITU 1999.

ITU 1.432 “B-ISDN user-network interface-physical layer specification”, ITU, 1993.

Benedetto, Divsalar, Montorsi and F. Pollara, “Serial Concatenation of Interleaved Codes: Performance Analysis, Design, and Iterative Decoding”, The Telecommunications and Data Acquisition Progress Report 42-126, Jet Propulsion Laboratory, Pasadena, Calif., pp. 1-26, Aug. 15, 1996.

Benedetto, Divsalar, Montorsi and F. Pollara, “A Soft-Output Maximum A Posteriori (MAP) Module to decode parallel and Serial Concatenated Codes”, The Telecommunications and Data Acquisition Progress Report 42-127, Jet Propulsion Laboratory, Pasadena, Calif., pp. 1-20, Nov. 15, 1996.

L. R. Bahl, J. Cocke, F. Jelinek, and J. Raviv, “Optimal Decoding of Linear Codes for Minimizing Symbol Error Rate,” IEEE Transactions on Information Theory, pp. 284-287, March 1974.

Divsalar and F. Pollara, “Turbo Codes for PCS Applications”, Proceedings of ICC'95, Seattle, Wash., pp. 54-59, June 1995.

D. Divsalar and F. Pollara, “Multiple Turbo Codes”, Proceedings of IEEE MILCOM95, San Diego, Calif., Nov. 5-8, 1995.

D. Divsalar and F. Pollara, “Soft-Output Decoding Algorithms in iterative Decoding of Turbo Codes,” The Telecommunications and Data Acquisition Progress Report 42-124, Jet Propulsion Laboratory, Pasadena, California, pp. 63-87, Feb. 15, 1995.

### SUMMARY OF THE INVENTION

Embodiments in accordance with the present invention are distinguished over conventional inner/outer coder schemes in that information regarding bit errors in the output of an inner decoder is provided by the inner decoder to the outer decoder, rather than being generated internally by the outer decoder. Thus, unlike conventional outer decoders, the outer decoder in accordance with preferred embodiments of the invention does not require a conventional first stage for determining errors in the output bit stream of the inner decoder based on the bits of the output bit stream themselves.

In a first preferred embodiment, a soft-output inner decoder is utilized in a conventional manner to generate a bit stream from a received symbol stream and to generate a bit error probabilities for each bit of its output bit stream. This bit error probabilities and the output bit stream of the inner decoder are then provided to an outer decoder where errors in the output of the inner decoder are corrected in accordance with the bit error probabilities.

In a second preferred embodiment, an LDPC coder is used as an inner encoder in a transmitter, and is used as an inner decoder in a receiver. Thus, unlike in conventional implementations, the LDPC coder is employed in an inner/outer coder scheme. In a receiver, the bit error information generated by the inner LDPC decoder is provided to an outer decoder where errors in the output of the inner LDPC decoder are corrected. Because a second stage of error correction is used, it becomes possible to reduce the block size utilized for the LDPC coding.

### BRIEF DESCRIPTION OF THE DRAWINGS

FIG. 1 shows elements of an ADSL transmitter and receiver that use inner and outer coders;

FIG. 2 shows a Coding Scheme;

FIG. 3 shows a SRC Scheme;

FIG. 4 shows BER curves for use of a Turbo coder as an inner encoder for the rate 4/6 64 QAM scheme in accordance with an embodiment of the invention;

FIG. 5 shows BER curves for use of a Turbo coder as an inner encoder for the rate 12/14 16384 QAM scheme in accordance with an embodiment of the invention;

FIG. 6 shows a process in accordance with a first preferred embodiment,

FIG. 7 shows a first process in accordance with a second preferred embodiment; and

FIG. 8 shows a second process in accordance with a second preferred embodiment.

### DETAILED DESCRIPTION OF PREFERRED EMBODIMENTS

1. Introduction

The preferred embodiments of the invention presented herein pertain to encoder structures having an inner encoder comprising a soft-output coding scheme, such as Trellis Code Modulation (TCM) or Turbo Code (TC), or a Low Density Parity Check (LDPC) coding scheme. An outer encoder in accordance with the preferred embodiments comprises a Reed-Solomon (RS) encoder. However, alternative embodiments may be implemented using other inner encoders that provide bit error or bit error probability information, and using other outer encoders that utilize bit error or bit error probability information.

A first preferred embodiment exploits features of a Maximum a Posteriori (MAP) decoder used as an inner soft-output decoder. The MAP decoder provides as output a bit stream and an error probability of each bit of the bit stream (referred to herein as bit error probability information). The bit error probability information is used in the outer decoder to facilitate greater error recovery in the outer decoder (in the case of RS codes this error recovery is doubled). This scheme is contrasted with conventional implementations such as conventional xDSL modems that employ an inner decoder for TCM that uses a Viterbi decoder. This provides only hard decisions as to the value of each output bit and outputs no probability or error information that can be used in the outer RS decoder.

For purposes of comparison, the preferred embodiments of the invention will be illustrated in the context an Asymmetric Digital Subscriber Line (ADSL) system using an outer encoder and an inner encoder.

2. System Model

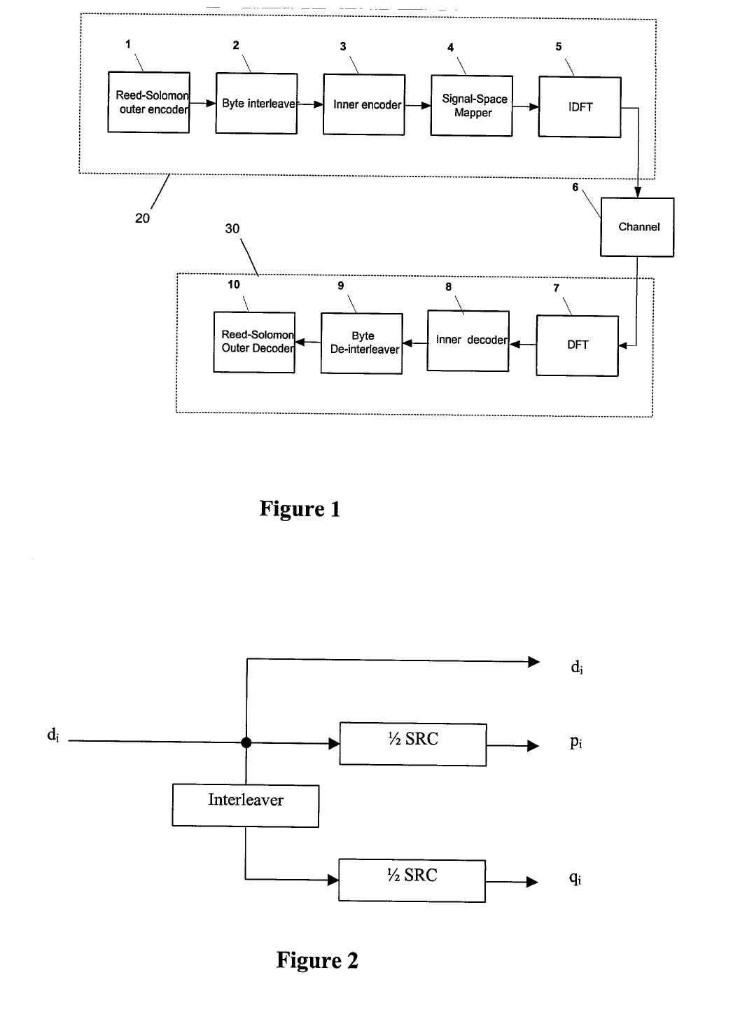

FIG. 1 shows a system model of a communication system comprising transmitting and receiving ADSL modems, such as is described in the Recommendation G.992.1 of the ITU. The system uses two dimensional multi-level signals for the inner encoder, as QAM. The transmitting modem 20 comprises a Reed-Solomon outer encoder 1, a byte interleaver 2, and an inner encoder 3 that produce an encoded bit stream from an input information bit stream. A signal-space mapper 4 maps the bit stream to symbols of a symbol constellation, and an inverse discrete Fourier transform module 5 modulates the symbols for transmission through a communication channel 6. In the receiving modem 30, a discrete Fourier transform module 7 receives the modulated signal from the communication channel 6 and converts it to a received bit stream. The receiving modem further comprises an inner decoder 8, a byte de-interleaver 9, and a Reed-Solomon outer decoder 10. The output of the outer decoder 10 is a reconstructed information bit stream.

3. Reed-Solomon (RS) Encoder

The RS outer encoder 1 of FIG. 1 is used very often to correct burst-errors in communication channels, such as telephone lines, deep-space communications, satellite communications, mobile communications, and CD players. The characteristic of an RS code is that it can correct up to R/2 symbols, where R is the number of check symbols used by the RS encoder.

R, the number of redundant check bytes c₀, c₁, . . . , c_{R-2}, c_{R-1} shall be appended to K information bytes m₀, m₁, . . . , m_{K-2}, m_{K-1} to form a RS codeword of size N=K+R bytes. The check bytes are computed from the message byte using the equation:

C(D)=M(D)D^{R} mod G(D) (1)

where:

M(D)=m₀D^{K-1}+m₁D^{K-2}+ . . . +m_{K-2}D+m_{K-1} (2)

is the message polynomial,

C(D)=c₀D^{R-1}+c₁D^{R-2}+ . . . +c_{R-2}D+c_{R-1} (3)

is the check polynomial, and

$$G ( D ) = {\prod }_{i = 0}^{R - 1} ( D - {α}^{i} ) \qquad ( 4 )$$

is the generator polynomial of the Reed-Solomon code, where the index of the product runs from i=0 to R−1. That is, C(D) is the remainder obtained from dividing M(D) DR by G(D). The arithmetic is performed in the Galois Field GF(256), where α is a primitive element that satisfies the primitive binary polynomial x⁸+x⁴+x³+x²+1 A data byte (d₇, d₆, . . . , d₁, d₀) is identified with the Galois Field element d₇α⁷+d₆α⁶+ . . . +d₁α+d₀

With this definition RS is able to correct up to R/2 symbols. If there are more than R/2 symbols with errors, RS will not be able to correct any of them. Because of this characteristic of RS, a high value for R is used, to make sure that the system is working error- free (assuming impulse noise of duration inferior to 0.5 ms).

The values of the redundancy to work error free are around 10-15%.

To improve the performance of the RS outer encoder, a byte interleaver 2 is used as indicated in FIG. 1.

3. The Soft-Inner Encoder-Decoder

In accordance with the first preferred embodiment, the inner encoder 3 of FIG. 1 is a TC. Two examples are provided herein addressing the cases of 64 QAM and 16384 QAM modulations to show how information about the probability of each symbol can be use to improve the performance of a RS outer encoder. The signal-space mapper 4 of FIG. 1 in these cases provides independent I&Q QAM Gray mapping.

3.1. Description of the Method for Implementation

3.1.1 Capacity Bounds

The minimum E_{b}/N₀ values to achieve the Shannon bound 64 QAM and 16384 QAM bounds for spectral efficiencies of 4 and 12 bits/s/Hz respectively are as in Table 1 for a BER=10⁻⁵.

TABLE 1
Shannon bounds.

| Spectral efficiency n | Shannon bound |
|---|---|
| [bit/s/Hz] | Eb/No [dB] |
| 4 | 5.6 |
| 12 | 24.7 |

The conversion from SNR of the QAM signal to E_{b}/N₀ is performed using the following relation:

E_{b}/N₀[dB]=SNR[dB]−10 log₁₀(η) [dB] (5)

where η is the number of information bits per symbol.

For a D-dimension modulation the following formulae are used:

$$\begin{matrix}SNR = \frac{E [ \vert {a}_{k}^{2} \vert ]}{E [ \vert {w}_{k}^{2} \vert ]} = \frac{E [ \vert {a}_{k}^{2} \vert ]}{D {σ}_{N}^{2}} = \frac{{E}_{av}}{D {σ}_{N}^{2}} & ( 6 ) \\ SNR = \frac{{E}_{s}}{D \frac{{N}_{0}}{2}} = \frac{η {E}_{b}}{D \frac{{N}_{0}}{2}} & ( 7 )\end{matrix}$$

where σ²_{N} is the noise variance in each of the D dimension and η is the number of information bits per symbol. From the above relations:

$${σ}_{N}^{2} = {{E}_{av} ( \frac{2 η {E}_{b}}{{N}_{0}} )}^{- 1} \qquad ( 8 )$$

3.1.2 Coding

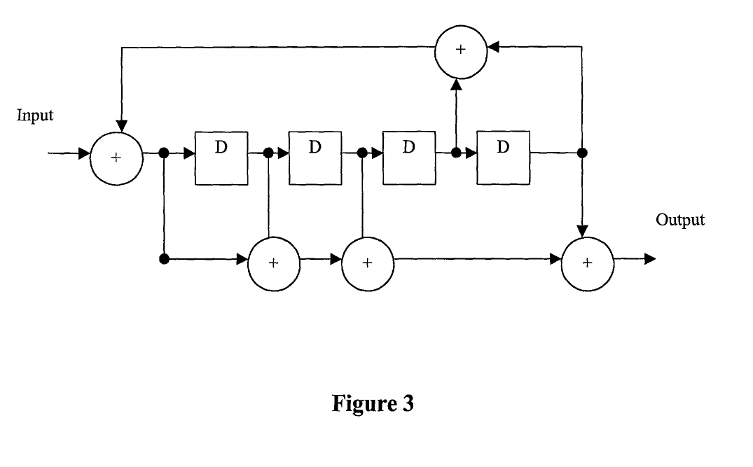

The coding scheme is shown in FIG. 2. The two systematic recursive codes (SRC) used are identical and are defined in FIG. 3. The code is described by the generating polynomials 35o and 23o.

3.1.3 Turbo Code Internal Interleaver

The interleaver of this embodiment is an LRI interleaver. The interleaving sequence of the LRI is as follows:

Determination of the interleaving buffer size.

| | |
|---|---|
| M: | Number of column in the interleaving buffer (M > 16). |
| N: | Number of rows in the interleaving buffer (N > 16). |
| BL: | Interleaving block size (BL = P × P >= M × N). |
| P: | Minimum prime number that is larger than M. |
| v: | Minimum primitive root of P. |

Making Basic Random Set Whose Length is M

C(0)=1; C(i+1)=vxC(i)mod P, i=0,1, . . . P−3 (9)

Making j-th Inter-row Permutation Pattern

By shifting output of step 2 one by one per inter-row, a Latin square matrix is made. The last (M−1)th column is processed specially in order to avoid low hamming weight phenomenon caused by the forced termination.

CLj(i)=C(j+imodM−1); CLj(M−1)=0; i=0,1, . . . M−2; j=0,1, . . . ,N−1 (10)

Row by Row 2D-Mapping of di to M×N Buffer

d*j (i)=i+Mxj , i=0, 1, . . . ,M−2 ; j=0,1, . . . , N−1 (11)

Permutating of 2D-Mapped Input Set di by the Permutation Pattern made in Point 3

d**j(i)=d*(N−j) (CL)N−j) (i)),, i=0,1, . . . , M−1;j=0,1, . . . , N−1 (12)

Reading a Permuted Input Set Column by Column, and Making Output Set

d′(j+Nxi)=d**j(i), i=0,1, . . . , M−1;j=0,1, . . . , N−1 (13)

Pruning Bits

d′ is pruned by deleting the 1-bits in order to adjust the output d′ to the input block length BL, where the deleted bits are non-existent bits in the input sequence. The pruning number L is defined as L=M×N−BL.

3.1.4. Coding And Modulation For 4 Bit/S/Hz Spectral Efficiency

3.1.4.1 Puncturing

In order to obtain a rate 4/6 code, the puncturing pattern used is shown in Table 2.

TABLE 2
Puncturing and Mapping for Rate 4/6 64 QAM

| | | | | |
|---|---|---|---|---|
| Information bit (d) | d₁ | d₂ | d₃ | d₄ |
| parity bit (p) | p₁ | — | — | — |
| parity bit (q) | — | — | q₃ | — |

| | |
|---|---|
| 8AM symbol (I) | (d₁, d₂, p₁) |
| 8AM symbol (Q) | (d₃, d₄, q₃) |
| 64 QAM symbol (I, Q) | (I,Q) = (d₁,d₂,p₁,d₃,d₄,q₃) |

3.1.4.2 Modulation

In this embodiment Gray mapping is used in each dimension. Four information bits are required to be sent using a 64 QAM constellation. For a rate 4/6 code and 64 QAM, the noise variance in each dimension is

Eₐᵥ=(8(49+25+9+1+25+49+49+9+49+1+25+9+25+1+9+1))A²/64=42A² (14)

$${σ}_{N}^{2} = {{E}_{av} ( \frac{2 η {E}_{b}}{{N}_{0}} )}^{- 1} = 42 {{A}^{2} ( \frac{2 \times 4 \times {E}_{b}}{{N}_{0}} )}^{- 1} = 5.25 {{A}^{2} ( \frac{{E}_{b}}{{N}_{0}} )}^{- 1} \qquad ( 15 )$$

The puncturing and mapping scheme is shown in Table 2 for 4 consecutive information bits that are encoded into 6 coded bits, therefore one 64 QAM symbol. The turbo encoder with the puncturing presented in Table 2 is a rate 4/6 turbo code which in conjunction with 64 QAM gives a spectral efficiency of 4 bits/s/Hz. Considering two independent Gaussian noises with identical variance σ²_{N}, the LLR can be determined independently for each I and Q. It is assumed that at time k u₁^{k}, u₂^{k} and u₃^{k} modulate the I component and u₄^{k}, u₅^{k} and u₆^{k} modulate the Q component of the 64 QAM scheme. At the receiver, the I and Q signals are treated independently in order to take advantage of the simpler formulae for the LLR values.

3.1.4.3 Bit Probabilities

From each received symbol, the bit probabilities for the three I dimension bits are computed as follows:

$$\begin{matrix}\begin{matrix}LLR ( {u}_{1}^{k} ) = log ( \frac{{\sum }_{i = 1}^{4} exp [ - \frac{1}{2 {σ}_{N}^{2}} {( {I}^{k} - {a}_{1 , i}^{k} )}^{2} ]}{{\sum }_{i = 1}^{4} exp [ - \frac{1}{2 {σ}_{N}^{2}} {( {I}^{k} - {a}_{0 , i}^{k} )}^{2} ]} ) = \\ = log ( \frac{\begin{matrix}exp [ - \frac{1}{2 {σ}_{N}^{2}} {( {I}^{k} - {A}_{4} )}^{2} ] + exp [ - \frac{1}{2 {σ}_{N}^{2}} {( {I}^{k} - {A}_{5} )}^{2} ] + \\ exp [ - \frac{1}{2 {σ}_{N}^{2}} {( {I}^{k} - {A}_{6} )}^{2} ] + exp [ - \frac{1}{2 {σ}_{n}^{2}} {( {I}^{k} - {A}_{7} )}^{2} ]\end{matrix}}{\begin{matrix}exp [ - \frac{1}{2 {σ}_{N}^{2}} {( {I}^{k} - {A}_{0} )}^{2} ] + exp [ - \frac{1}{2 {σ}_{N}^{2}} {( {I}^{k} - {A}_{1} )}^{2} ] + \\ exp [ - \frac{1}{2 {σ}_{N}^{2}} {( {I}^{k} - {A}_{2} )}^{2} ] + exp [ - \frac{1}{2 {σ}_{n}^{2}} {( {I}^{k} - {A}_{3} )}^{2} ]\end{matrix}} )\end{matrix} & ( 16 ) \\ \begin{matrix}LLR ( {u}_{2}^{k} ) = log ( \frac{{\sum }_{i = 1}^{4} exp [ - \frac{1}{2 {σ}_{N}^{2}} {( {I}^{k} - {a}_{1 , i}^{k} )}^{2} ]}{{\sum }_{i = 1}^{4} exp [ - \frac{1}{2 {σ}_{N}^{2}} {( {I}^{k} - {a}_{0 , i}^{k} )}^{2} ]} ) = \\ = log ( \frac{\begin{matrix}exp [ - \frac{1}{2 {σ}_{N}^{2}} {( {I}^{k} - {A}_{2} )}^{2} ] + exp [ - \frac{1}{2 {σ}_{N}^{2}} {( {I}^{k} - {A}_{3} )}^{2} ] + \\ exp [ - \frac{1}{2 {σ}_{N}^{2}} {( {I}^{k} - {A}_{6} )}^{2} ] + exp [ - \frac{1}{2 {σ}_{n}^{2}} {( {I}^{k} - {A}_{7} )}^{2} ]\end{matrix}}{\begin{matrix}exp [ - \frac{1}{2 {σ}_{N}^{2}} {( {I}^{k} - {A}_{0} )}^{2} ] + exp [ - \frac{1}{2 {σ}_{N}^{2}} {( {I}^{k} - {A}_{1} )}^{2} ] + \\ exp [ - \frac{1}{2 {σ}_{N}^{2}} {( {I}^{k} - {A}_{4} )}^{2} ] + exp [ - \frac{1}{2 {σ}_{n}^{2}} {( {I}^{k} - {A}_{5} )}^{2} ]\end{matrix}} )\end{matrix} & ( 17 ) \\ \begin{matrix}LLR ( {u}_{3}^{k} ) = log ( \frac{{\sum }_{i = 1}^{4} exp [ - \frac{1}{2 {σ}_{N}^{2}} {( {I}^{k} - {a}_{1 , i}^{k} )}^{2} ]}{{\sum }_{i = 1}^{4} exp [ - \frac{1}{2 {σ}_{N}^{2}} {( {I}^{k} - {a}_{0 , i}^{k} )}^{2} ]} ) = \\ = log ( \frac{\begin{matrix}exp [ - \frac{1}{2 {σ}_{N}^{2}} {( {I}^{k} - {A}_{1} )}^{2} ] + exp [ - \frac{1}{2 {σ}_{N}^{2}} {( {I}^{k} - {A}_{5} )}^{2} ] + \\ exp [ - \frac{1}{2 {σ}_{N}^{2}} {( {I}^{k} - {A}_{3} )}^{2} ] + exp [ - \frac{1}{2 {σ}_{n}^{2}} {( {I}^{k} - {A}_{7} )}^{2} ]\end{matrix}}{\begin{matrix}exp [ - \frac{1}{2 {σ}_{N}^{2}} {( {I}^{k} - {A}_{0} )}^{2} ] + exp [ - \frac{1}{2 {σ}_{N}^{2}} {( {I}^{k} - {A}_{4} )}^{2} ] + \\ exp [ - \frac{1}{2 {σ}_{N}^{2}} {( {I}^{k} - {A}_{2} )}^{2} ] + exp [ - \frac{1}{2 {σ}_{n}^{2}} {( {I}^{k} - {A}_{6} )}^{2} ]\end{matrix}} )\end{matrix} & ( 18 )\end{matrix}$$

An analogous computation effort is required for the bits of the Q dimension, the I^{k} being replaced with the Q^{k} demodulated value in order to evaluate LLR(u₄^{k}), LLR(u₅^{k}) and LLR(u₆^{k}).

The bit error probabilities are provided to the outer decoder where they are used by the outer decoder to detect the location of the erroneous bits and to selectively correct the erroneous bits.

As discussed above, conventional outer decoders comprise a first stage that determines bit error information from the output bits of the inner decoder themselves, and a second stage that corrects bits in accordance with the bit error information. In accordance with the first preferred embodiment of the present invention, the first stage of the conventional outer decoder is replaced with a stage that generates a hard bit error decision for each bit using externally provided bit error probability information, such as by a thresholding procedure, and provides the bit error information to a second stage, such a conventional second stage, where bit errors are corrected in accordance with the bit error information. Those of ordinary skill in the art will be capable of modifying any of the conventional outer decoders of this type to accept externally generated bit error probability information and generated bit error information therefrom for use in the second stage of the decoder. Therefore no further detailed discussion of the outer decoder is provided here apart from the discussion in section 5 below.

3.1.4.4 Simulation Results

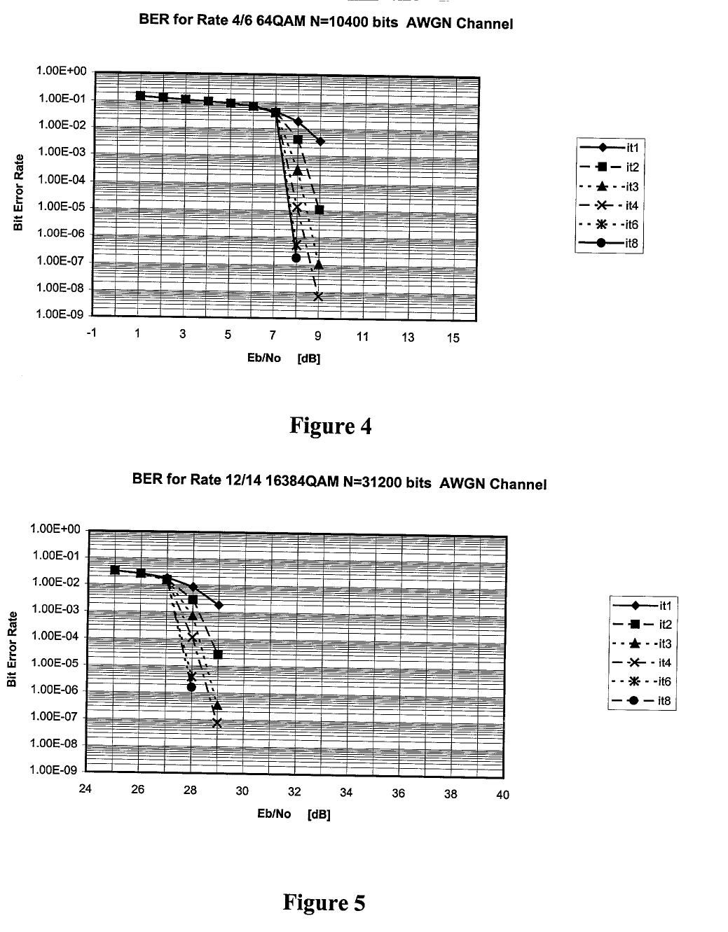

FIG. 4 shows simulation results for 10,400 information bits with an S-type interleaver. A BER of 10⁻⁷ can be achieved after 8 iterations at E_{b}/N₀=8.3 dB.

3.1.5 Coding And Modulation For 12 Bit/S/Hz Spectral Efficiency

A second example in accordance with the first preferred embodiment utilizes a rate 12/14 coding scheme with 16384 QAM.

3.1.5.1 Puncturing

In order to obtain a rate 12/14 code, a puncturing pattern as shown in Table 3 is used.

TABLE 3
Puncturing and Mapping for Rate 12/14 16384 QAM

| | | | | | | | | | | | | |
|---|---|---|---|---|---|---|---|---|---|---|---|---|
| Information | d₁ | d₂ | d₃ | d₄ | d₅ | d₆ | d₇ | d₈ | d₉ | d₁₀ | d₁₁ | d₁₂ |
| bit (d) | | | | | | | | | | | | |
| parity bit (p) | p₁ | | | | | | | | | | | |
| parity bit (q) | | | | | | | q₇ | | | | | |

| | |
|---|---|
| 128AM | (d₁, d₂, d₃, d₄d₅, d₆, p₁) |
| symbol (I) | |
| 128AM | (d₇, d₈, d₉, d₁₀, d₁₁, d₁₂, p₇) |
| symbol (Q) | |
| 16384 QAM | (d₁, d₂, d₃, d₄d₅, d₆, p₁, d₇, d₈, d₉, d₁₀, d₁₁, d₁₂, p₇) |
| symbol (I, Q) | |

3.1.5.2 Modulation

For a 16384 QAM constellation with points at -127A, -125A, -123A, -121A, -119A, -117A, -115A, -113A, -111A, -109A, -107A, -105A, -103A, -101A, -99A, -97A, -95A, -93A, -91A, -89A, -87A, -85A, -83A, -81A, -79A, -77A, -75A, -73A, -71A, -69A, -67A, -65A, -63A, -61A, -59A, -57A, -55A, -53A, -51A, -49A, -47A, -45A, -43A, -41A, -39A, -37A, - 35A, -33A, -31A, -29A, -27A, -25A, -23A, -21A, -19A, -17A, -15A, -13A, -11A, -9A, -7A, -5A, -3A, -A, A, 3A, 5A, 7A, 9A, 11A, 13A, 15A, 17A, 19A, 21A, 23A, 25A, 27A, 29A, 31A, 33A, 35A, 37A, 39A, 41A, 43A, 45A, 47A, 49A, 51A, 53A, 55A, 57A, 59A, 61A, 63A, 65A, 67A, 69A, 71A, 73A, 75A, 77A, 79A, 81A, 83A, 95A, 87A, 89A, 91A, 93A, 95A, 97A, 99A, 101A, 103A, 105A, 107A, 109A, 111A, 113A, 115A, 117A, 119A, 121A, 123A, 125A, 127A, Eₐᵥ is:

Eₐᵥ=5461A² (19)

It is assumed that at time k the symbol u^{k}=(u₁^{k}, u₂^{k}, u₃^{k}, u₄^{k}, u₅^{k}, u₆^{k}, u₇^{k}, u₈^{k}, u₉^{k}, u₁₀^{k}, u₁₁^{k}, u₁₂^{k}, u₁₃^{k}, u₁₄^{k}) is sent though the channel. It is assumed that at time k the symbol u₁^{k}, u₂^{k}, u₃^{k}, u₄^{k}, u₅^{k}, u₆^{k} and u₇^{k} modulate the I component and u₈^{k}, u₉^{k}, u₁₀^{k}, u₁₁^{k}, u₁₂^{k}, u₁₃^{k} and u₁₄^{k} modulate the Q component of a 16384 QAM scheme.

For a rate 12/14 code and 16384 QAM, the noise variance is:

$${σ}_{N}^{2} = {{E}_{av} ( \frac{2 η {E}_{b}}{{N}_{0}} )}^{- 1} = 5461 {{A}^{2} ( \frac{2 \times 6 \times {E}_{b}}{{N}_{0}} )}^{- 1} = 455.08 {{A}^{2} ( \frac{{E}_{b}}{{N}_{0}} )}^{- 1} \qquad ( 20 )$$

In order to study the performance of this scheme, a rate 6/7 turbo code and a 128AM is used. The 16384 QAM scheme will achieve a similar performance in terms of bit error rate (BER) at twice the spectral efficiency, assuming an ideal demodulator. The puncturing and mapping scheme shown in Table 8 is for 12 consecutive information bits that are coded into 14 encoded bits, therefore, one 16384 QAM symbol. The turbo encoder is a rate 12/14 turbo code, which in conjunction with 16384 QAM, gives a spectral efficiency of 12 bits/s/Hz.

3.1.5.3 Bit Probabilities

The 128AM symbol is defined as u^{k}=(u₁^{k}, u₂^{k}, u₃^{k}, u₄^{k}, u₅^{k}, u₆^{k}k, u₇^{k}), where u₁^{k} is the most significant bit and u₇^{k} is the least significant bit. The following set can be defined.

bit-1-is-0={A₀, A₁, A₃, A₄, A₅, A₆, A₇, A₈, A₉, A₁₀, A₁₁, A₁₂, A₁₃, A₁₄, A₁₅, A₁₆, A₁₇, A₁₈, A₁₉, A₂₀, A₂₁, A₂₂, A₂₃, A₂₄, A₂₅, A₂₆, A₂₇, A₂₈, A₂₉, A₃₀, A₃₁, A₃₂, A₃₃, A₃₄, A₃₅, A₃₆, A₃₇, A₃₈, A₃₉, A₄₀, A₄₁, A₄₂, A₄₃, A₄₄, A₄₅, A₄₆, A₄₇, A₄₈, A₄₉, A₅₀, A₅₁, A₅₂, A₅₃, A₅₄, A₅₅, A₅₆, A₅₇, A₅₈, A₅₉, A₆₀, A₆₁, A₆₂, A₆₃}

bit-1-is-1={A₆₄, A₆₅, A₆₆, A₆₇, A₆₈, A₆₉, A₇₀, A₇₁, A₇₂, A₇₃, A₇₄, A₇₅, A₇₆, A₇₇, A₇₈, A₇₉, A₈₀, A₈₁, A₈₂, A₈₃, A₈₄, A₈₅, A₈₆, A₈₇, A₈₈, A₈₉, A₉₀, A₉₁, A₉₂, A₉₃, A₉₄, A₉₅, A₉₆, A₉₇, A₉₈, A₉₉, A₁₀₀, A₁₀₁, A₁₀₂, A₁₀₃, A₁₀₄, A₁₀₅, A₁₀₆, A₁₀₇, A₁₀₈, A₁₀₉, A₁₁₀, A₁₁₁, A₁₁₂, A₁₁₃, A₁₁₄, A₁₁₅, A₁₁₆, A₁₁₇, A₁₁₈, A₁₁₉, A₁₂₀, A₁₂₁, A₁₂₂, A₁₂₃, A₁₂₄, A₁₂₅, A₁₂₆, A₁₂₇}

bit-2-is-0={A₀, A₁, A₂, A₃, A₄, A₅, A₆, A₇, A₈, A₉, A₁₀, A₁₁, A₁₂, A₁₃, A₁₄, A₁₅, A₁₆, A₁₇, A₁₈, A₁₉, A₂₀, A₂₁, A₂₂, A₂₃, A₂₄, A₂₅, A₂₆, A₂₇, A₂₈, A₂₉, A₃₀, A₃₁, A₉₆, A₉₇, A₉₈, A₉₉, A₁₀₀, A₁₀₁, A₁₀₂, A₁₀₃, A₁₀₄, A₁₀₅, A₁₀₆, A₁₀₇, A₁₀₈, A₁₀₉, A₁₁₀, A₁₁₁, A₁₁₂, A₁₁₃, A₁₁₄, A₁₁₅, A₁₁₆, A₁₁₇, A₁₁₈, A₁₁₉, A₁₂₀, A₁₂₁, A₁₂₂, A₁₂₃, A₁₂₄, A₁₂₅, A₁₂₆, A₁₂₇}

bit-2-is-1={A₃₂, A₃₃, A₃₄, A₃₅, A₃₆, A₃₇, A₃₈, A₃₉, A₄₀, A₄₁, A₄₂, A₄₃, A₄₄, A₄₅, A₄₆, A₄₇, A₄₈, A₄₉, A₅₀, A₅₁, A₅₂, A₅₃, A₅₄, A₅₅, A₅₆, A₅₇, A₅₈, A₅₉, A₆₀, A₆₁, A₆₂, A₆₃, A₆₄, A₆₅, A₆₆, A₆₇, A₆₈, A₆₉, A₇₀, A₇₁, A₇₂, A₇₃, A₇₄, A₇₅, A₇₆, A₇₇, A₇₈, A₇₉, A₈₀, A₈₁, A₈₂, A₈₃, A₈₄, A₈₅, A₈₆, A₈₇, A₈₈, A₈₉, A₉₀, A₉₁, A₉₂, A₉₃, A₉₄, A₉₅}

bit-3-is-0={A₀, A₁, A₂, A₃, A₄, A₅, A₆, A₇, A₈, A₉, A₁₀, A₁₁, A₁₂, A₁₃, A₁₄, A₁₅, A₄₈, A₄₉, A₅₀, A₅₁, A₅₂, A₅₃, A₅₄, A₅₅, A₅₆, A₅₇, A₅₈, A₅₉, A₆₀, A₆₁, A₆₂, A₆₃, A₆₄, A₆₅, A₆₆, A₆₇, A₆₈, A₆₉, A₇₀, A₇₁, A₇₂, A₇₃, A₇₄, A₇₅, A₇₆, A₇₇, A₇₈, A₇₉, A₁₁₂, A₁₁₃, A₁₁₄, A₁₁₅, A₁₁₆, A₁₁₇, A₁₁₈, A₁₁₉, A₁₂₀, A₁₂₁, A₁₂₂, A₁₂₃, A₁₂₄, A₁₂₅, A₁₂₆, A₁₂₇}

bit-3-is-1={A₁₆, A₁₇, A₁₈, A₁₉, A₂₀, A₂₁, A₂₂, A₂₃, A₂₄, A₂₅, A₂₆, A₂₇, A₂₈, A₂₉, A₃₀, A₃₁, A₃₂, A₃₃, A₃₄, A₃₅, A₃₆, A₃₇, A₃₈, A₃₉, A₄₀, A₄₁, A₄₂, A₄₃, A₄₄, A₄₅, A₄₆, A₄₇, A₈₀, A₈₁, A₈₂, A₈₃, A₈₄, A₈₅, A₈₆, A₈₇, A₈₈, A₈₉, A₉₀, A₉₁, A₉₂, A₉₃, A₉₄, A₉₅, A₉₆, A₉₇, A₉₈, A₉₉, A₁₀₀, A₁₀₁, A₁₀₂, A₁₀₃, A₁₀₄, A₁₀₅, A₁₀₆, A₁₀₇, A₁₀₈, A₁₀₉, A₁₁₀, A₁₁₁}

bit-4-is-0={A₀, A₁, A₂, A₃, A₄, A₅, A₆, A₇, A₂₄, A₂₅, A₂₆, A₂₇, A₂₈, A₂₉, A₃₀, A₃₁, A₃₂, A₃₃, A₃₄, A₃₅, A₃₆, A₃₇, A₃₈, A₃₉, A₅₆, A₅₇, A₅₈, A₅₉, A₆₀, A₆₁, A₆₂, A₆₃, A₆₄, A₆₅, A₆₆, A₆₇, A₆₈, A₆₉, A₇₀, A₇₁, A₈₈, A₈₉, A₉₀, A₉₁, A₉₂, A₉₃, A₉₄, A₉₅, A₉₆, A₉₇, A₉₈, A₉₉, A₁₀₀, A₁₀₁, A₁₀₂, A₁₀₃, A₁₂₀, A₁₂₁, A₁₂₂, A₁₂₃, A₁₂₄, A₁₂₅, A₁₂₆, A₁₂₇}

bit-4-is-1={A₈, A₉, A₁₀, A₁₁, A₁₂, A₁₃, A₁₄, A₁₅, A₁₆, A₁₇, A₁₈, A₁₉, A₂₀, A₂₁, A₂₂, A₂₃, A₄₀, A₄₁, A₄₂, A₄₃, A₄₄, A₄₅, A₄₆, A₄₇, A₄₈, A₄₉, A₅₀, A₅₁, A₅₂, A₅₃, A₅₄, A₅₅, A₇₂, A₇₃, A₇₄, A₇₅, A₇₆, A₇₇, A₇₈, A₇₉, A₈₀, A₈₁, A₈₂, A₈₃, A₈₄, A₈₅, A₈₆, A₈₇, A₁₀₄, A₁₀₅, A₁₀₆, A₁₀₇, A₁₀₈, A₁₀₉, A₁₁₀, A₁₁₁, A₁₁₂, A₁₁₃, A₁₁₄, A₁₁₅, A₁₁₆, A₁₁₇, A₁₁₈, A₁₁₉,}

bit-5-is-0={A₀, A₁, A₂, A₃, A₁₂, A₁₃, A₁₄, A₁₅, A₁₆, A₁₇, A₁₈, A₁₉, A₂₈, A₂₉, A₃₀, A₃₁, A₃₂, A₃₃, A₃₄, A₃₅, A₄₄, A₄₅, A₄₆, A₄₇, A₄₈, A₄₉, A₅₀, A₅₁,, A₆₀, A₆₁, A₆₂, A₆₃, A₆₄, A₆₅, A₆₆, A₆₇, A₇₆, A₇₇, A₇₈, A₇₉, A₈₀, A₈₁, A₈₂, A₈₃, A₉₂, A₉₃, A₉₄, A₉₅, A₉₆, A₉₇, A₉₈, A₉₉, A₁₀₈, A₁₀₉, A₁₁₀, A₁₁₁, A₁₁₂, A₁₁₃, A₁₁₄, A₁₁₅, A₁₂₄, A₁₂₅, A₁₂₆, A₁₂₇}

bit-5-is-1={A₄, A₅, A₆, A₇, A₈, A₉, A₁₀, A₁₁, A₂₀, A₂, A₂₂, A₂₃, A₂₄, A₂₅, A₂₆, A₂₇, A₃₆, A₃₇, A₃₈, A₃₉, A₄₀, A₄₁, A₄₂, A₄₃, A₅₂, A₅₃, A₅₄, A₅₅, A₅₆, A₅₇, A₅₈, A₅₉, A₆₈, A₆₉, A₇₀, A₇₁, A₇₂, A₇₃, A₇₄, A₇₅, A₈₄, A₈₅, A₈₆, A₈₇, A₈₈, A₈₉, A₉₀, A₉₁, A₁₀₀, A₁₀₁, A₁₀₂, A₁₀₃, A₁₀₄, A₁₀₅, A₁₀₆, A₁₀₇, A₁₁₆, A₁₁₇, A₁₁₈, A₁₁₉, A₁₂₀, A₁₂₁, A₁₂₂, A₁₂₃}

bit-6-is-0={A₂, A₃, A₄, A₅, A₁₀, A₁₁, A₁₂, A₁₃, A₁₈, A₁₉, A₂₀, A₂₁, A₂₆, A₂₇, A₂₈, A₂₉, A₃₄, A₃₅, A₃₆, A₃₇, A₄₂, A_{43,}, A₄₅, A₅₀, A₅₁, A₅₂, A₅₃, A₅₈, A₅₉, A₆₀, A₆₁, A₆₆, A₆₇, A₆₈, A₆₉, A₇₄, A₇₅, A₇₆, A₇₇, A₈₂, A₈₃, A₈₄, A₈₅, A₉₀, A₉₁, A₉₂, A₉₃, A₉₈, A₉₉, A₁₀₀, A₁₀₁, A₁₀₆, A₁₀₇, A₁₀₈, A₁₀₉, A₁₁₄, A₁₁₅, A₁₁₆, A₁₁₇, A₁₂₂, A₁₂₃, A₁₂₄, A₁₂₅}

bit-6-is-1={A₀, A₁, A₆, A₇, A₈, A₉, A₁₄, A₁₅, A₁₆, A₁₇, A₂₂, A₂₃, A₂₄, A₂₅, A₃₀, A₃₁, A₃₂, A₃₃, A₃₈, A₃₉, A₄₀, A₄₁, A₄₆, A₄₇, A₄₈, A₄₉, A₅₄, A₅₅, A₅₆, A₅₇, A₆₂, A₆₃, A₆₄, A₆₅, A₇₀, A₇₁, A₇₂, A₇₃, A₇₈, A₇₉, A₈₀, A₈₁, A₈₆, A₈₇, A₈₈, A₈₉, A₉₄, A₉₅, A₉₆, A₉₇, A₁₀₂, A₁₀₃, A₁₀₄, A₁₀₅, A₁₁₀, A₁₁₂, A₁₁₃, A₁₁₈, A₁₁₉, A₁₂₀, A₁₂₁, A₁₂₆, A₁₂₇}

bit-7-is-0={A₀, A₃, A₄, A₇, A₈, A₁₁, A₁₂, A₁₅, A₁₆, A₁₉, A₂₀, A₂₃, A₂₄, A₂₇, A₂₈, A₃₁, A₃₂, A₃₅, A₃₆, A₃₉, A₄₀, A₄₃, A₄₇, A₄₈, A₅₁, A₅₂, A₅₅, A₅₆, A₅₉, A₆₀, A₆₃, A₆₄, A₆₇, A₆₈, A₇₁, A₇₂, A₇₅, A₇₆, A₇₉, A₈₀, A₈₃, A₈₄, A₈₇, A₈₈, A₉₂, A₉₅, A₉₆, A₉₉, A₁₀₀, A₁₀₃, A₁₀₄, A₁₀₇, A₁₀₈, A₁₁₁, A₁₁₂, A₁₁₅, A₁₁₆, A₁₁₉, A₁₂₀, A₁₂₃, A₁₂₄, A₁₂₇}

bit-7-is-1={A₁, A₂, A₅, A₆, A₉, A₁₀, A₁₃, A₁₄, A₁₇, A₁₈, A₂₁, A₂₂, A₂₅, A₂₆, A₂₉, A₃₀, A₃₃, A₃₄, A₃₇, A₃₈, A₄₁, A₄₂, A₄₅, A₄₆, A₄₉, A₅₀, A₅₃, A₅₄, A₅₇, A₅₈, A₆₁, A₆₂, A₆₅, A₆₆, A₆₉, A₇₀, A₇₃, A₇₄, A₇₇, A₇₈, A₈₁, A₈₂, A₈₅, A₈₆, A₈₉, A₉₀, A₉₃, A₉₄, A₉₇, A₉₈, A₁₀₁, A₁₀₂, A₁₀₅, A₁₀₆, A₁₀₉, A₁₁₀, A₁₁₃, A₁₁₄, A₁₁₇, A₁₁₈, A₁₂₁, A₁₂₂, A₁₂₅, A₁₂₆}

From each received symbol, R^{k}, the bit probabilities are computed as follows:

$$\begin{matrix}LLR ( {u}_{1}^{k} ) = log ( \frac{{\sum }_{{A}_{i} ∈ bit \text{-} 1 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 1 \text{-} is \text{-} 0} exp ( - \frac{1}{2 {σ}_{N}^{2}} \vert \vert {R}^{k} - {A}_{j} \vert \vert )} ) & ( 21 ) \\ LLR ( {u}_{2}^{k} ) = log ( \frac{{\sum }_{{A}_{i} ∈ bit \text{-} 2 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 2 \text{-} is \text{-} 0} exp ( - \frac{1}{2 {σ}_{N}^{2}} \vert \vert {R}^{k} - {A}_{j} \vert \vert )} ) & ( 22 ) \\ LLR ( {u}_{3}^{k} ) = log ( \frac{{\sum }_{{A}_{i} ∈ bit \text{-} 3 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 3 \text{-} is \text{-} 0} exp ( - \frac{1}{2 {σ}_{N}^{2}} \vert \vert {R}^{k} - {A}_{j} \vert \vert )} ) & ( 23 ) \\ LLR ( {u}_{4}^{k} ) = log ( \frac{{\sum }_{{A}_{i} ∈ bit \text{-} 4 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 4 \text{-} is \text{-} 0} exp ( - \frac{1}{2 {σ}_{N}^{2}} \vert \vert {R}^{k} - {A}_{j} \vert \vert )} ) & ( 24 ) \\ LLR ( {u}_{5}^{k} ) = log ( \frac{{\sum }_{{A}_{i} ∈ bit \text{-} 5 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 5 \text{-} is \text{-} 0} exp ( - \frac{1}{2 {σ}_{N}^{2}} \vert \vert {R}^{k} - {A}_{j} \vert \vert )} ) & ( 25 ) \\ LLR ( {u}_{6}^{k} ) = log ( \frac{{\sum }_{{A}_{i} ∈ bit \text{-} 6 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 6 \text{-} is \text{-} 1} exp ( - \frac{1}{2 {σ}_{N}^{2}} \vert \vert {R}^{k} - {A}_{j} \vert \vert )} ) & ( 26 ) \\ LLR ( {u}_{7}^{k} ) = log ( \frac{{\sum }_{{A}_{i} ∈ bit \text{-} 7 \text{-} is \text{-} 1} exp ( - \frac{1}{2 {σ}_{N}^{2}} \vert \vert {R}^{k} - {A}_{i} \vert \vert )}{{\sum }_{{A}_{j} ∈ bit \text{-} 7 \text{-} is \text{-} 0} exp ( - \frac{1}{2 {σ}_{N}^{2}} \vert \vert {R}^{k} - {A}_{j} \vert \vert )} ) & ( 27 )\end{matrix}$$

An analogous computation effort is required for the bits of the Q dimension, the I^{k} being replaced with the Q^{k} demodulated value i order to evaluate LLR(u₈^{k}), LLR(u₉^{k}), LLR(u₁₀^{k}), LLR(u₁₁^{k}), LLR(u₁₂^{k}), LLR(u₁₃^{k}) and LLR(u₁₄^{k}).

The bit error probabilities are provided to the outer decoder where they are used by the outer decoder to generate bit error information indicating the location of the erroneous bits and to selectively correct the erroneous bits.

As discussed above, conventional outer decoders comprise a first stage that determines bit error information from the output bits of the inner decoder themselves, and a second stage that corrects bits in accordance with the bit error information. In accordance with the first preferred embodiment of the present invention, the first stage of the conventional outer decoder is replaced with a stage that generates a hard bit error decision for each bit using externally provided bit error probability information, such as by a thresholding procedure, and provides the bit error information to a second stage, such a conventional second stage, where bit errors are corrected in accordance with the bit error information. Those of ordinary skill in the art will be capable of modifying any of the conventional outer decoders of this type to accept externally generated bit error probability information and generated bit error information therefrom for use in the second stage of the decoder. Therefore no further detailed discussion of the outer decoder is provided here apart from the discussion in section 5 below.

These probabilities are used by the outer decoder to detect the location of the erroneous bits.

3.1.5.4 Simulation Results

FIG. 5 shows the simulation results for 31200 information bits. A BER of 10⁻⁷ can be achieved after 8 iterations at E_{b}/N₀=28.25 dB.

4. IDFT use for ADSL Systems

After the mapper, the signal is sent to the IDFT, shown as 5 in FIG. 1 and to the channel, shown as 6 in FIG. 1.

5. Use of the Information by the Reed-Solomon Outer Decoder

The received signal is sent to the DFT block, 7 in FIG. 1, and to the inner decoder 7 in FIG. 1.

The probabilities in equations (16), (17) and (18) for the case of 4 bit/s/Hz and the probabilities of equations (21), (22), (23), (24), (25), (26) and (27) for the case of 12 bit/s/Hz are used for the RS decoder, shown as 9 in FIG. 1, in the following way:

The reliability of the received data is determined with the reliability of the MAP decoder. These data and associated bit error probabilities are carried through the deinterleaver placed between the inner decoder and the outer decoder. The Reed-Solomon uses as indication of error placement the worst of the bit error probabilities. Note that the MAP decoder may assign poor probabilities to all data associated with a frame.

While the first preferred embodiment utilizes turbo coding for the inner encoder and RS for the outer decoder, it will of course work with any soft-output inner encoder that provides bit error probabilities and outer encoders that utilize bit error probability information. This include turbo code base Maximum a Posteriori (MAP), Logarithmic MAP (LOGMAP), Maximum LAGMAP (MAXLOGMAP), soft-output Viterbi Algorithm (SOVA), Turbo Block Codes, as well as inner encoder using a single convolutional code as such trellis encoding of G.992.1 and G.992.2. It is recognized that the use of soft-output decoders on this non-turbo encoder will also give the same benefit. The significant point to recognize is the use of the inner soft-output decoder and that the outer decoder can take advantage of this information.

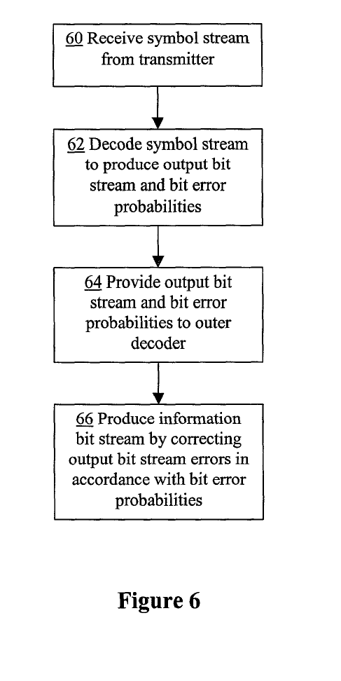

Accordingly, in accordance with the first preferred embodiment, there is a process for decoding a symbol stream with forward error correction to produce an information bit stream. This process is illustrated in FIG. 6. A symbol stream is received 60 from a o transmitter. The symbol stream is decoded 62 in an inner decoder using soft-output decoding to provide an output bit stream and associated bit error probabilities. The bit error probabilities and the output bit stream are provided 64 to an outer decoder, and the outer decoder produces 66 an information bit stream from the output bit stream using the bit error probabilities.

6. Second Preferred Embodiment using Inner Sum-Product Coding

In a second preferred embodiment, a sum-product algorithm inner encoder and decoder, such as LDPC coders, are used in a transmitter and receiver, respectively. The second preferred embodiment differs from the first preferred embodiment in that the sum- product inner decoder provides bit error information for its output bit stream, i.e. information indicating the position of each erroneous bit that requires correction by the outer decoder. The bit error information is provided to the outer decoder and used to select bits from the inner decoder output stream for correction in the outer decoder. This embodiment is preferred for its simplicity of implementation.

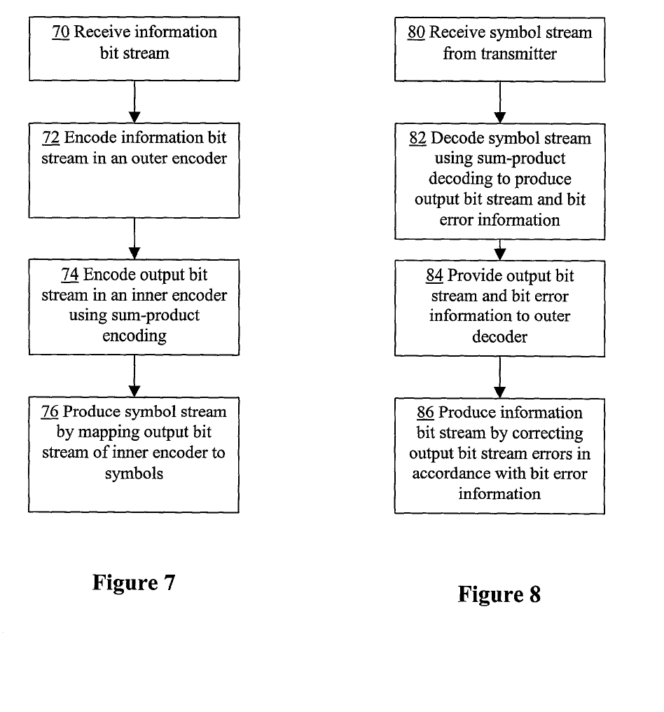

Accordingly, in accordance with the second preferred embodiment, there is a process in a transmitter for encoding a symbol stream with forward error correction from an information bit stream. As shown in FIG. 7, an information bit stream is received 70 and is encoded in an outer encoder 72. The output of the outer encoder is encoded 74 in an inner encoder using sum-product encoding. A symbol stream is then produced 76 by mapping an output bit stream of the inner encoder.

Further, in accordance with the second preferred embodiment, there is a process in a receiver for decoding a symbol stream with forward error correction to produce an information bit stream. As shown in FIG. 8, a symbol stream is received 80 from a transmitter. The symbol stream is decoded 82 in an inner decoder using sum-product decoding to provide an output bit stream and bit error information for the output bit stream. The bit error information and the output bit stream are provided 86 to an outer decoder, and the outer decoder produces 88 an information bit stream from the bit error information and the output bit stream.

Further embodiments of the invention pertain to a transmitter or receiver that performs processing as described above. Typically such transmitter or receiver will comprise at least one processor and storage media coupled to the at least one processor and containing programming code for performing processing as described above.

What is claimed is:

1. A process for decoding a symbol stream with forward error correction to produce an information bit stream comprising:
receiving the symbol stream from a transmitter;
decoding the symbol stream in an inner decoder using soft-output decoding to produce an output bit stream and associated bit error probabilities;
providing to an outer decoder the bit error probabilities and the output bit stream from the inner decoder; and
producing an information bit stream in the outer decoder by correcting errors in the output bit stream in accordance with the bit error probabilities from the inner decoder.

2. The method recited in claim 1, wherein said soft-output decoder is a Maximum a Posteriori (MAP) decoder.

3. The method recited in claim 1, wherein said soft-output decoder is a Logarithmic MAP (LOGMAP) decoder.

4. The method recited in claim 1, wherein said soft-output decoder is a Maximum LOGMAP (MAXLOGMAP) decoder.

5. The method recited in claim 1, wherein said soft-output decoder is a soft-output Viterbi Algorithm (SOVA) decoder.

6. The method recited in claim 1, wherein said outer decoder is a RS decoder.

7. The method recited in claim 1, wherein producing an information bit stream in accordance with the bit error probabilities from the inner decoder comprises:
generating, from said bit error probabilities, bit error information indicating bits requiring correction by the outer decoder; and correcting errors in accordance with said bit error information.

8. The method recited in claim 7, wherein generating said bit error information comprises subjecting said bit error probabilities to a thresholding procedure.

9. A process for decoding a symbol stream with forward error correction to produce an information bit stream comprising:
receiving the symbol stream from a transmitter;
decoding the symbol stream in an inner decoder using sum-product decoding to provide an output bit stream and bit error information for the output bit stream;
providing to an outer decoder the bit error information and the output bit stream; and
producing an information bit stream in the outer decoder from the bit error information and the output bit stream.

10. The method recited in claim 9, wherein said sum-product decoding comprises LDPC decoding.

11. The method recited in claim 9, wherein said outer decoder is a RS decoder.

12. The method recited in claim 9, wherein producing an information bit stream comprises correcting errors in said output bit stream in accordance with said bit error information.

13. A process for encoding a symbol stream with forward error correction from an information bit stream comprising:
receiving the information bit stream;
encoding the information bit stream in an outer encoder producing an output bit stream;
encoding the output bit stream of the outer encoder in an inner encoder using sum- product encoding; and producing a symbol stream by mapping an output bit stream of the inner encoder to symbols.

14. The method recited in claim 13, wherein said outer encoder is a RS encoder.

15. The method recited in claim 13, wherein said sum-product encoding comprises LDPC encoding.
